(19) United States
(12) Patent Application Publication
(10) Pub. No.: US 2018/0178749 A1
(43) Pub. Date: Jun. 28, 2018

(54) Beltevator

(71) Applicant: Michael S. Tomlinson, Waterford, MI (US)

(72) Inventor: Michael S. Tomlinson, Waterford, MI (US)

(73) Assignee: Michael S. Tomlinson, Waterford, MI (US)

(21) Appl. No.: 15/390,991

(22) Filed: Dec. 27, 2016

(51) Int. Cl. B60R 22/12

(52) U.S. Cl. CPC B60R 22/12

(57) ABSTRACT

A seatbelt pillow creates spacing for the seatbelt to lay off the chest of the user. Therefore, the seatbelt pillow can reduce wrinkles, prevent fray wear and provide cushioning for the neck and breast lines of the passengers wearing seatbelts. The seatbelt pillow also may provide improved safety for the user, providing, for example, reduced head injury criteria (HIC) as compared to a conventional shoulder belt without the seatbelt pillow.

### BACKGROUND OF THE INVENTION

The present invention relates to seatbelt accessories and, more particularly, to a seatbelt cushion that reduces wrinkles on shirts and ties while cushioning the neck and breast line and providing improved seatbelt safety to the vehicle occupant.

Many motorists and passengers complain about the wearing of seatbelts for two reasons. First, seat belts often wrinkle their shirts and ties. Second, seatbelts are often uncomfortable and are sometimes not very clean. Seatbelts create wrinkles and frays on shirts and ties. Seatbelts also create discomfort on wearer's neck and breast lines.

Conventional seatbelt accessories may pad the seatbelt or provide a softer material to go around the seatbelt, but the seatbelt is still pressed along a user's clothes and across their chest.

As can be seen, there is a need for an improved seatbelt accessory that may minimize wrinkling of the wearer's clothes while providing enhanced comfort and safety for the wearer.

### SUMMARY OF THE INVENTION

In one aspect of the present invention, a seatbelt pillow comprises a resilient, pliable material, having a covering; and a strap adapted to connect the seatbelt pillow to a seatbelt.

These and other features, aspects and advantages of the present invention will become better understood with reference to the following drawings, description and claims.

### BRIEF DESCRIPTION OF THE DRAWINGS

FIG. 1 is a front view of a seatbelt pillow according to an exemplary embodiment of the present invention;

FIG. 2 is a perspective view of the seatbelt pillow of FIG. 1, with its attachment strap disconnected and ready for application on a seatbelt;

FIG. 3 is another perspective view of the seatbelt pillow of FIG. 1, in use;

FIG. 4 is another perspective view of the seatbelt pillow of FIG. 1, in use;

FIG. 5 is a further perspective view of the seatbelt pillow of FIG. 1, in use;

FIG. 6 is a perspective view of a seatbelt pillow having an alternative attachment method, according to another exemplary embodiment of the present invention; and

FIGS. 7 through 31 show test results for studies of the product.

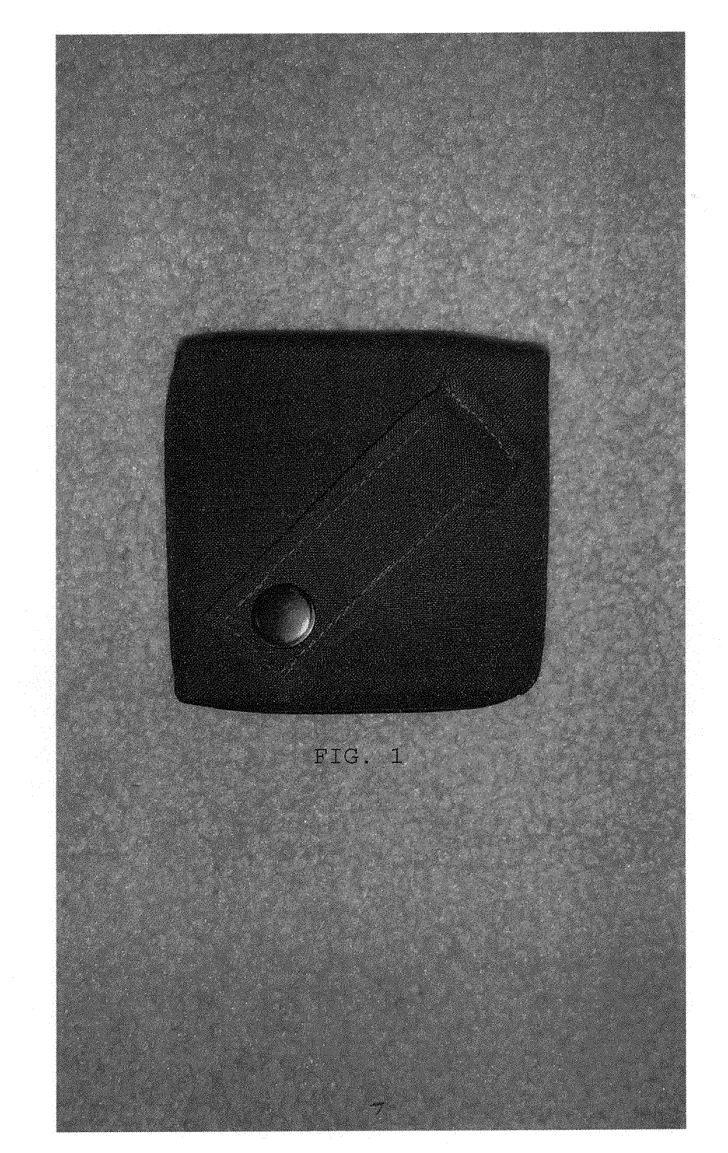

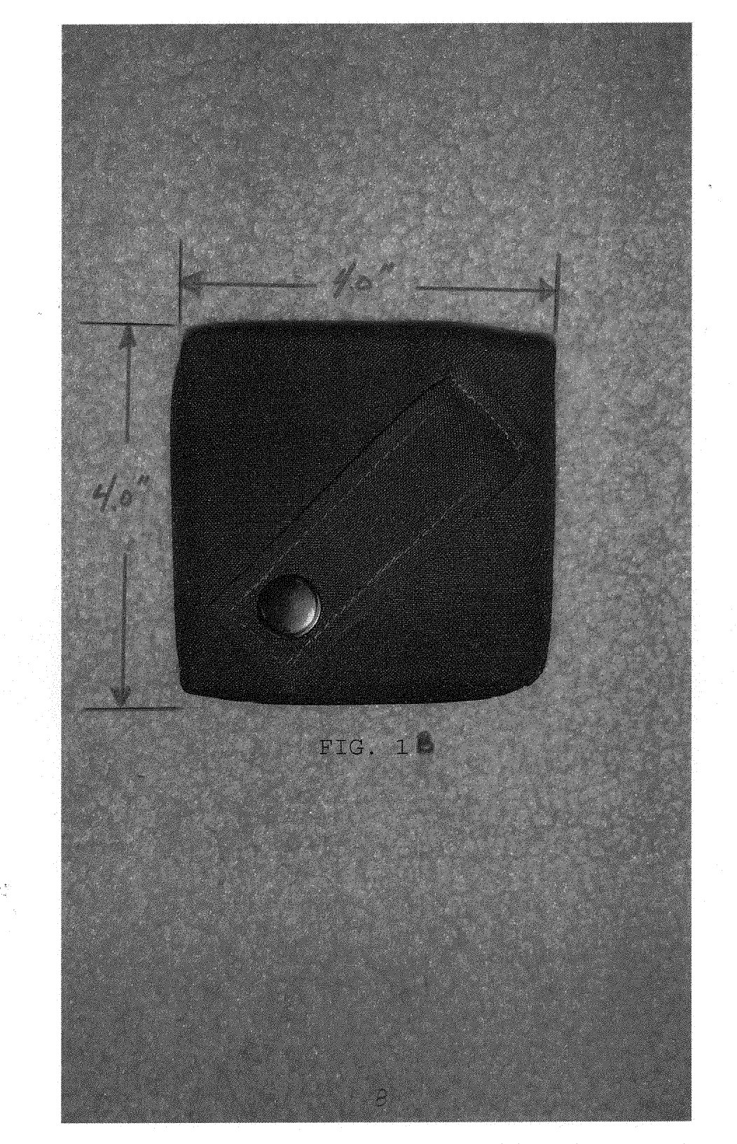

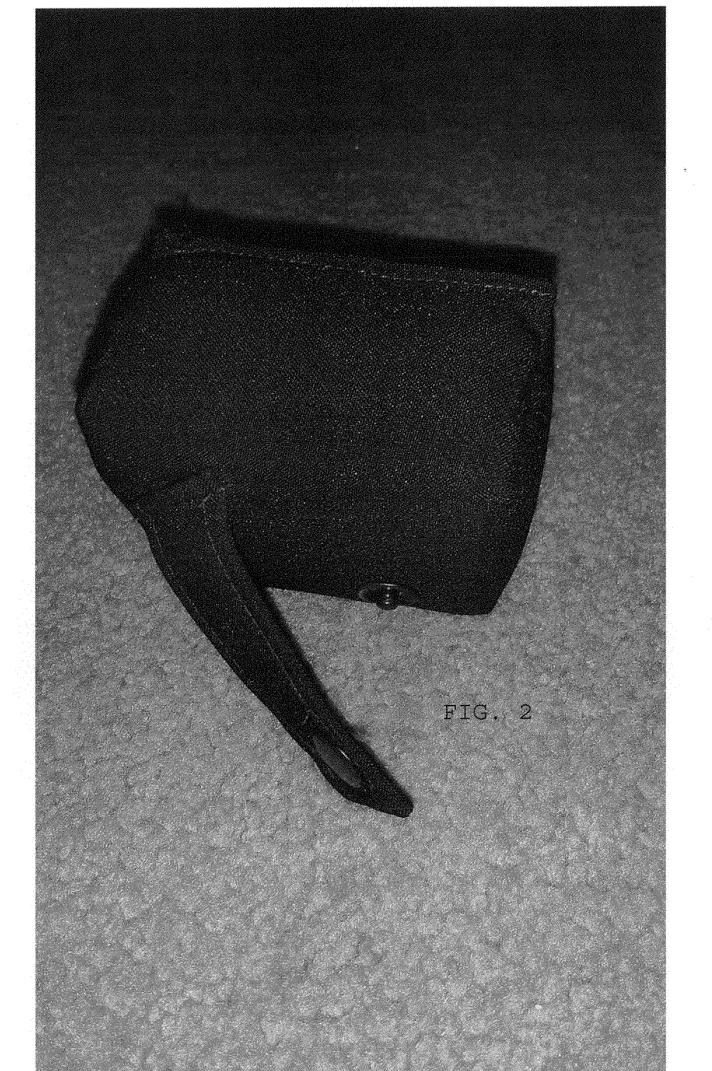

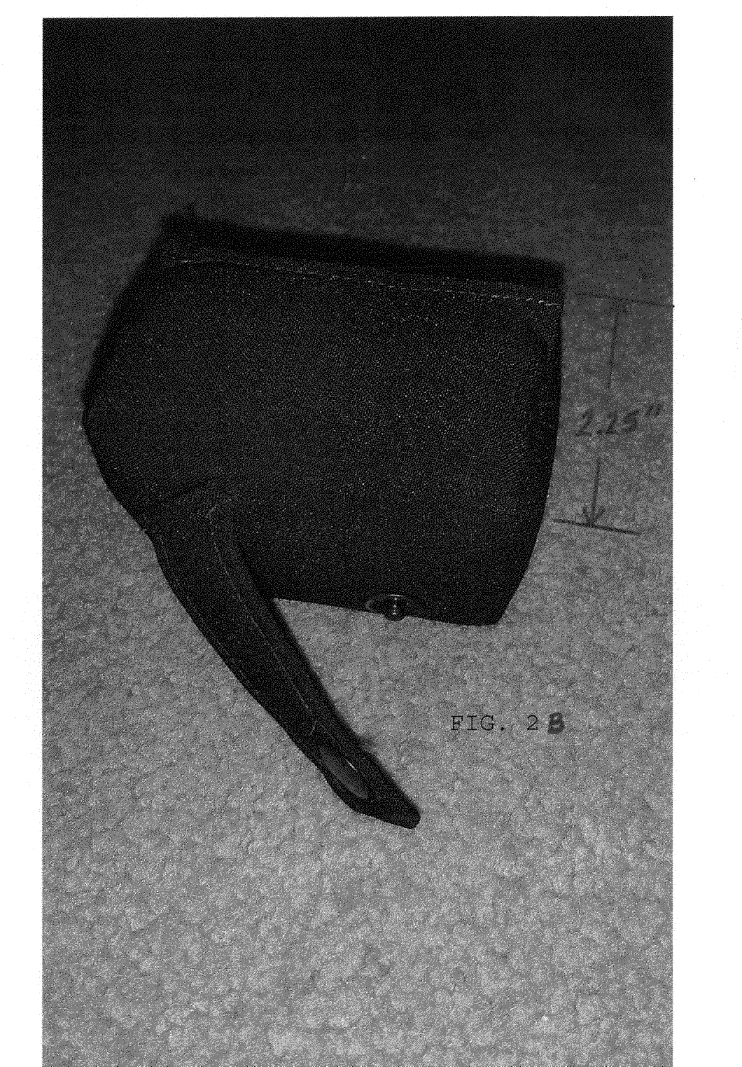

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating

The general principles of the invention, since the scope of the invention is best defined by the appended claims.

Broadly, an embodiment of the present invention provides a seatbelt pillow that creates a spacing for the seatbelt to lay off the chest of the user. Therefore, the seatbelt pillow can reduce wrinkles, prevent fray wear and provide cushioning for the neck and breast lines of the passengers wearing seatbelts. The seatbelt pillow also may provide improved safety for the user, providing, for example, reduced head injury criteria (HIC) as compared to a conventional shoulder belt without the seatbelt pillow.

Referring to the Figures, the seatbelt pillow may be from about 1 to about 3 inches thick, typically about 2 inches thick, and may attach to a seatbelt by various mechanisms such as with a hook and loop fastener, for example. The seatbelt pillow may be in various sizes, typically rectangular or square, and may be from about 2 to about 6 inches, typically about 4 inches, on each side. The seatbelt pillow may be a foam pad, or other soft, pliable material, covered with a covering. The covering may be various materials, such as cotton, vinyl, leather, or the like. The covering can include a stain resistant fabric or application. The covering can be in various colors and designs. The covering may include a reading glasses holder or a sun glasses pocket, for example.

Straps, such as Velcro straps, snapped straps, etc., may be applied to and extend from the covering. The straps allow the fastening of the seatbelt pillow to seatbelts of various widths and thicknesses. After application to the seatbelt, the seatbelt pillow can be positioned in the middle of the passenger's chest. With a spacing of approximately 2 inches off the chest line, the seatbelt pillow can allow the seatbelt to stand off the passenger, but will compress when seatbelt action is applied. When in a normal state, the standoff allows the seatbelt to reduce the amount of contact on the passenger and will minimize or prevent wrinkle, fray or discomfort on the neck and breast lines.

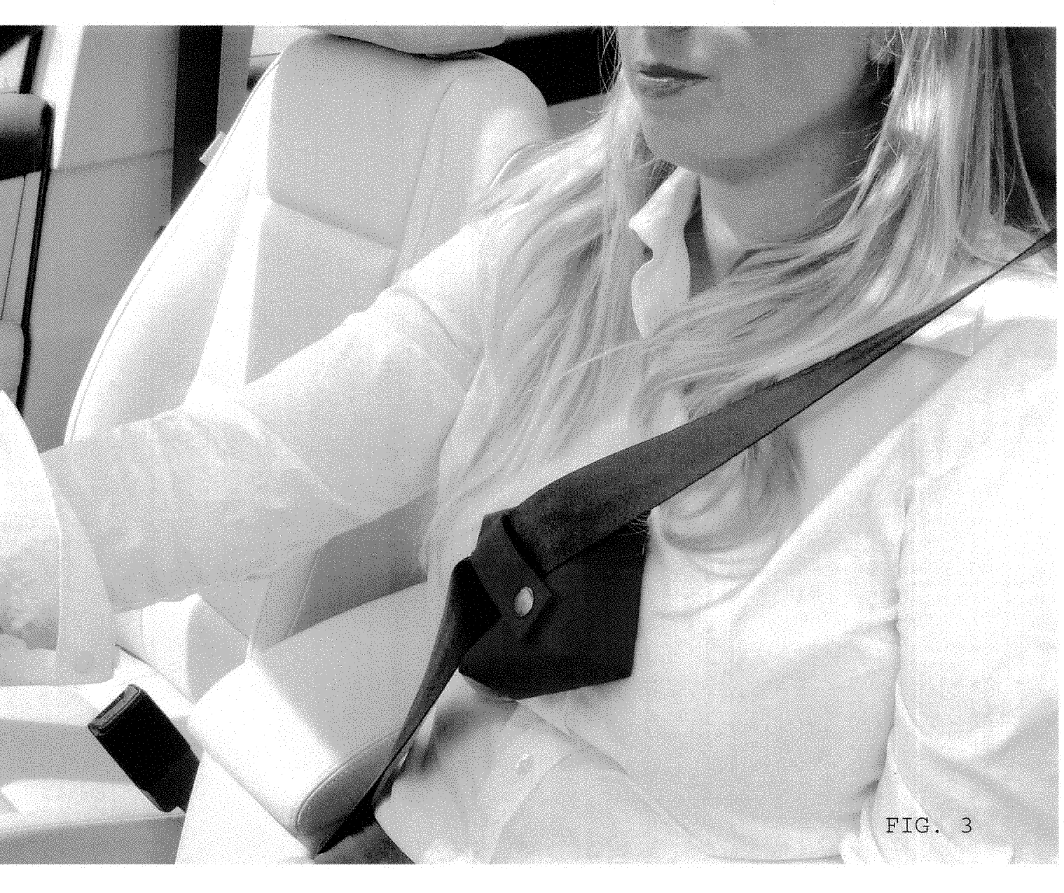

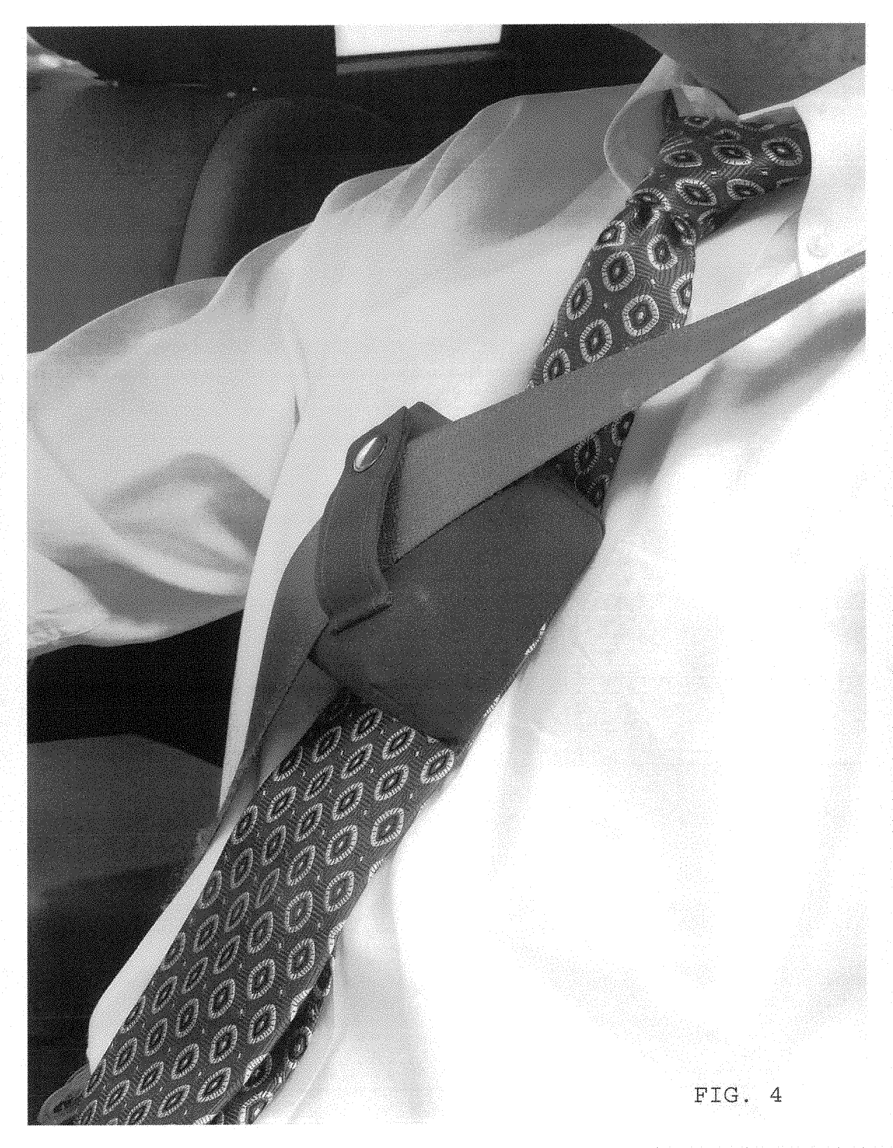

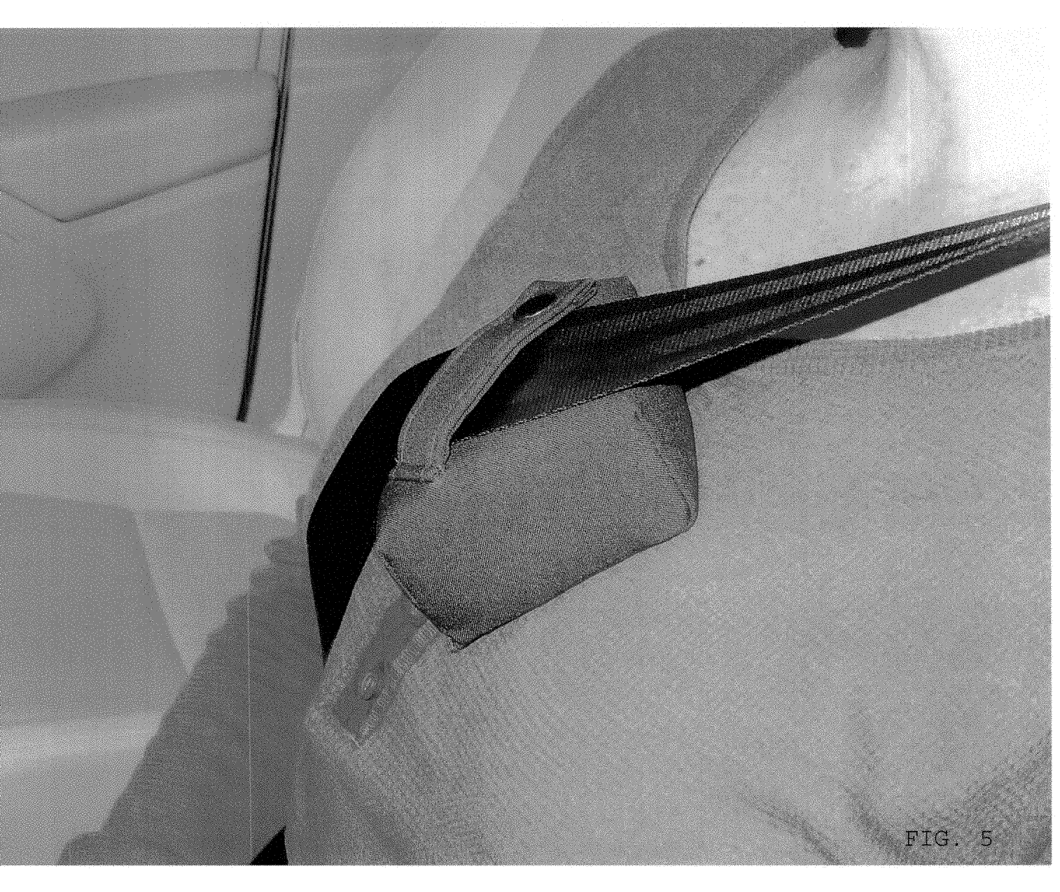

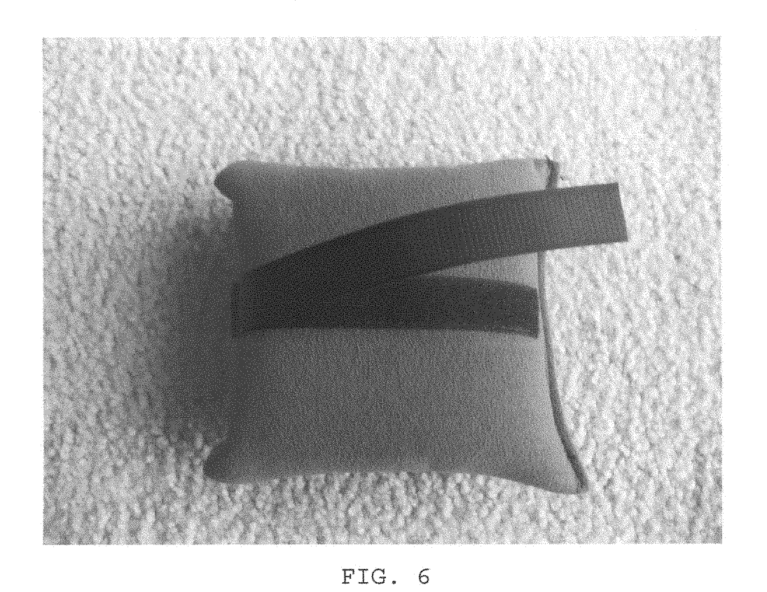

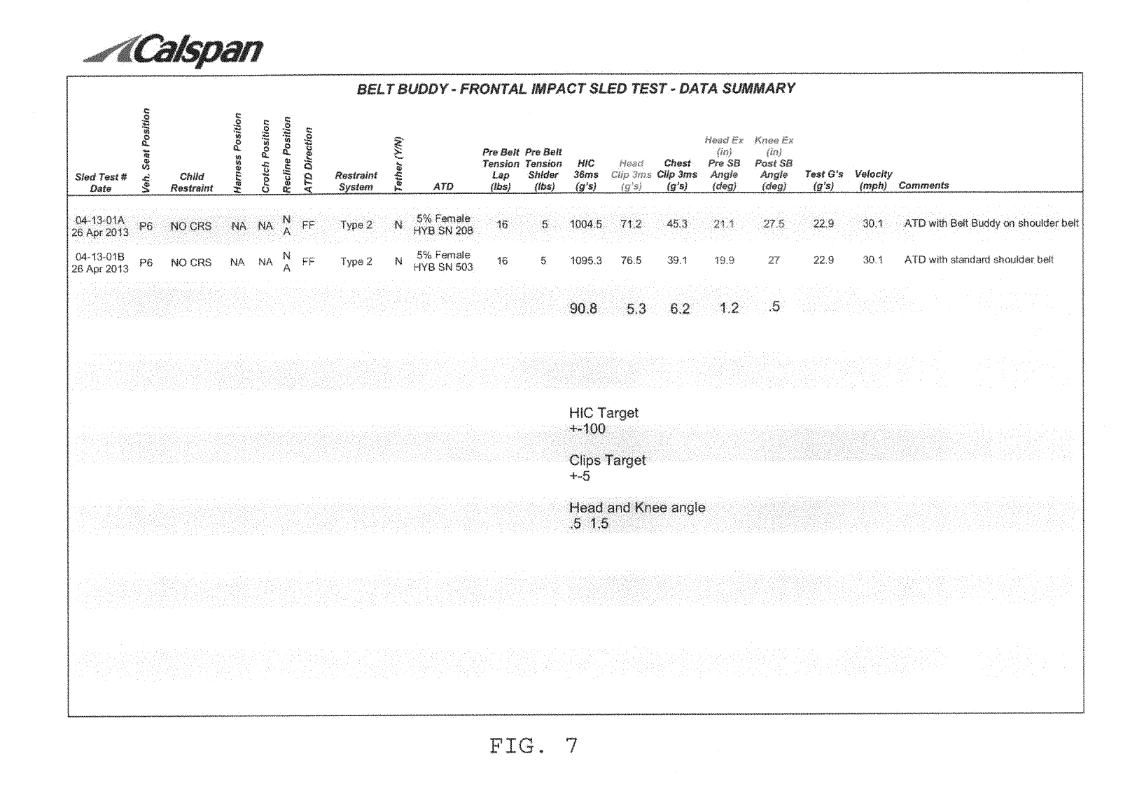

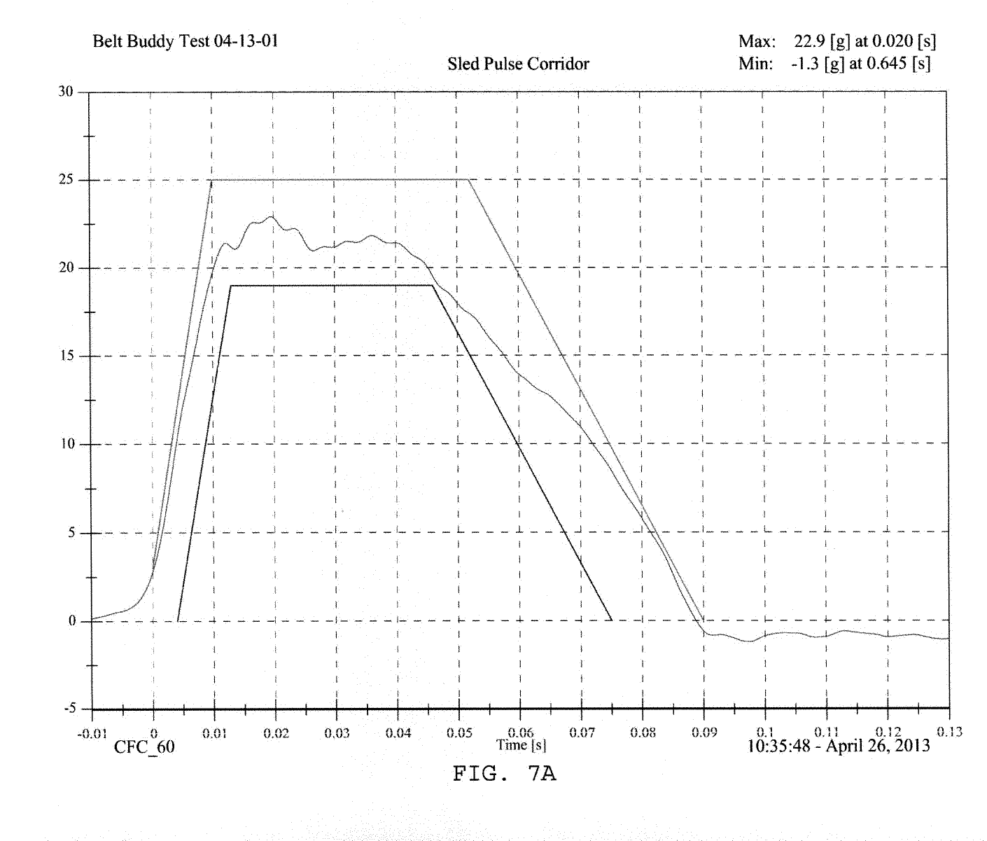

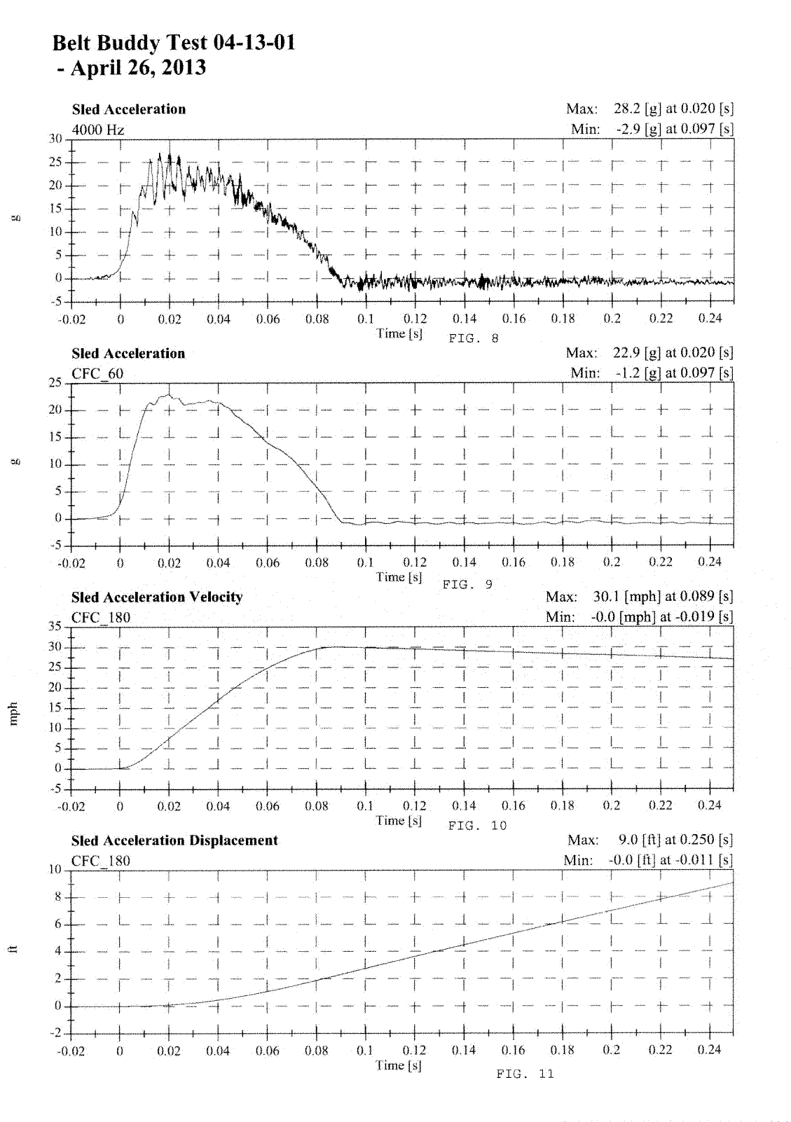

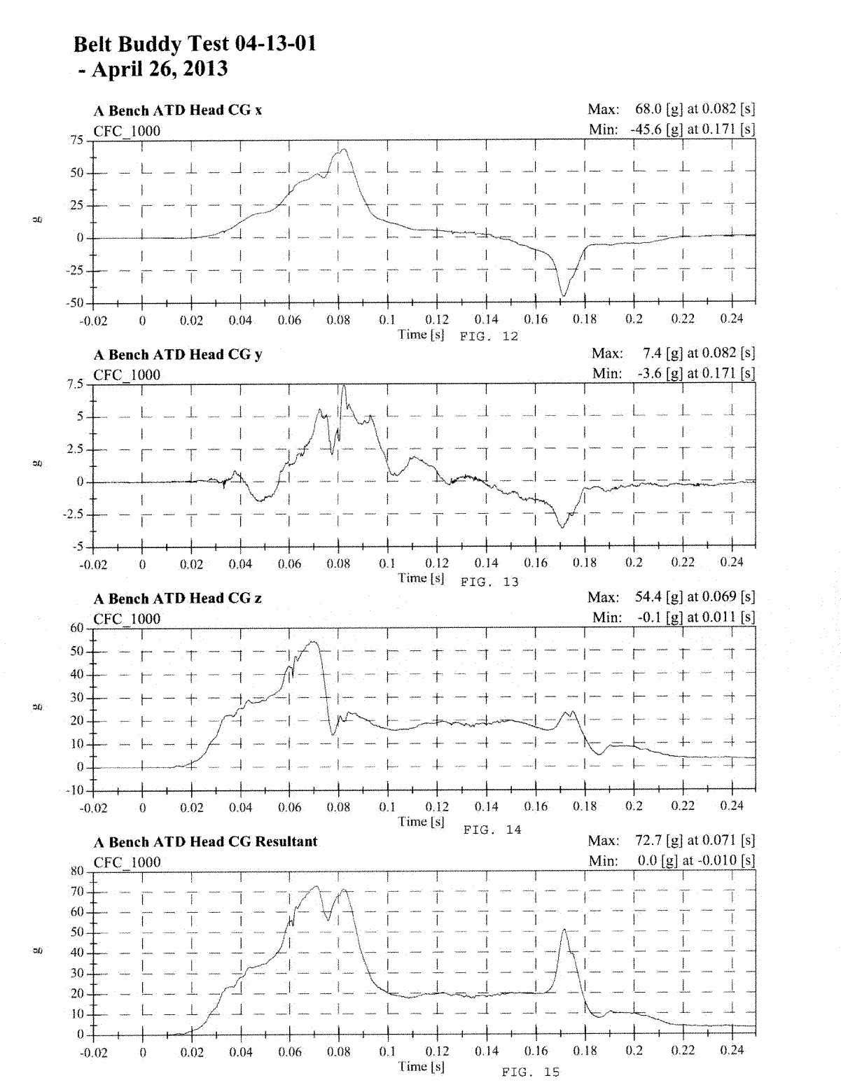

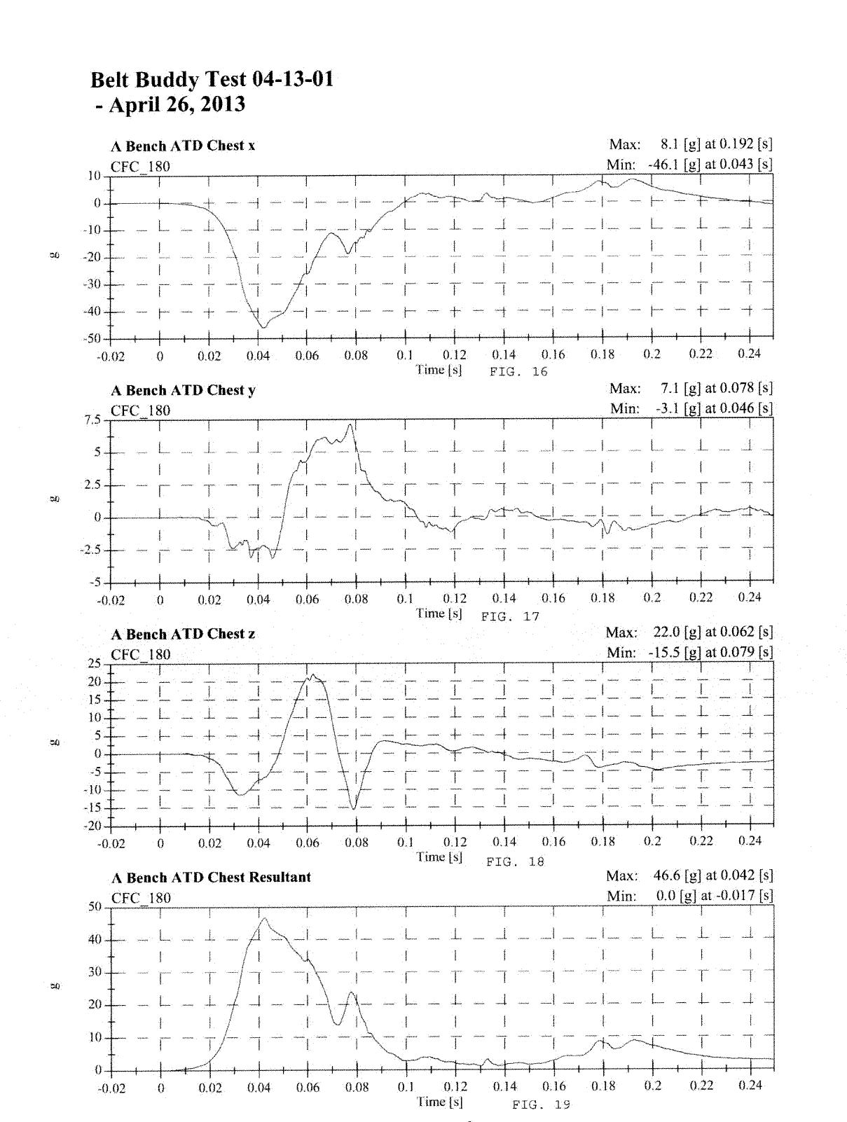

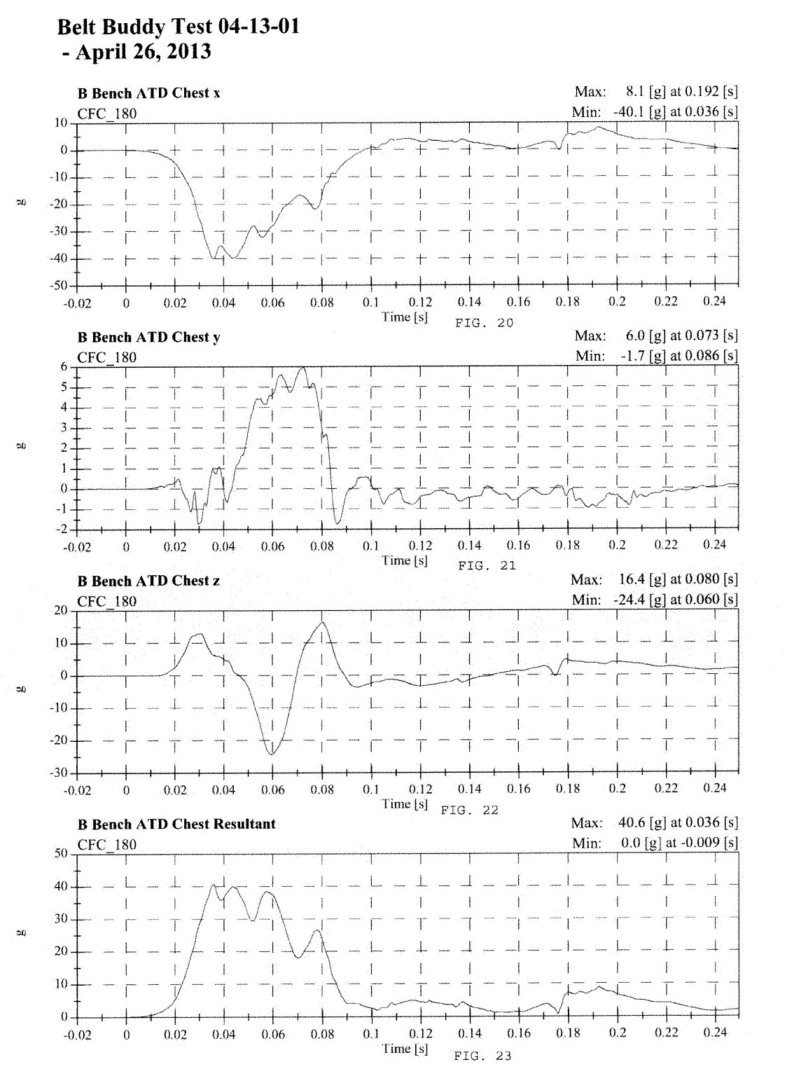

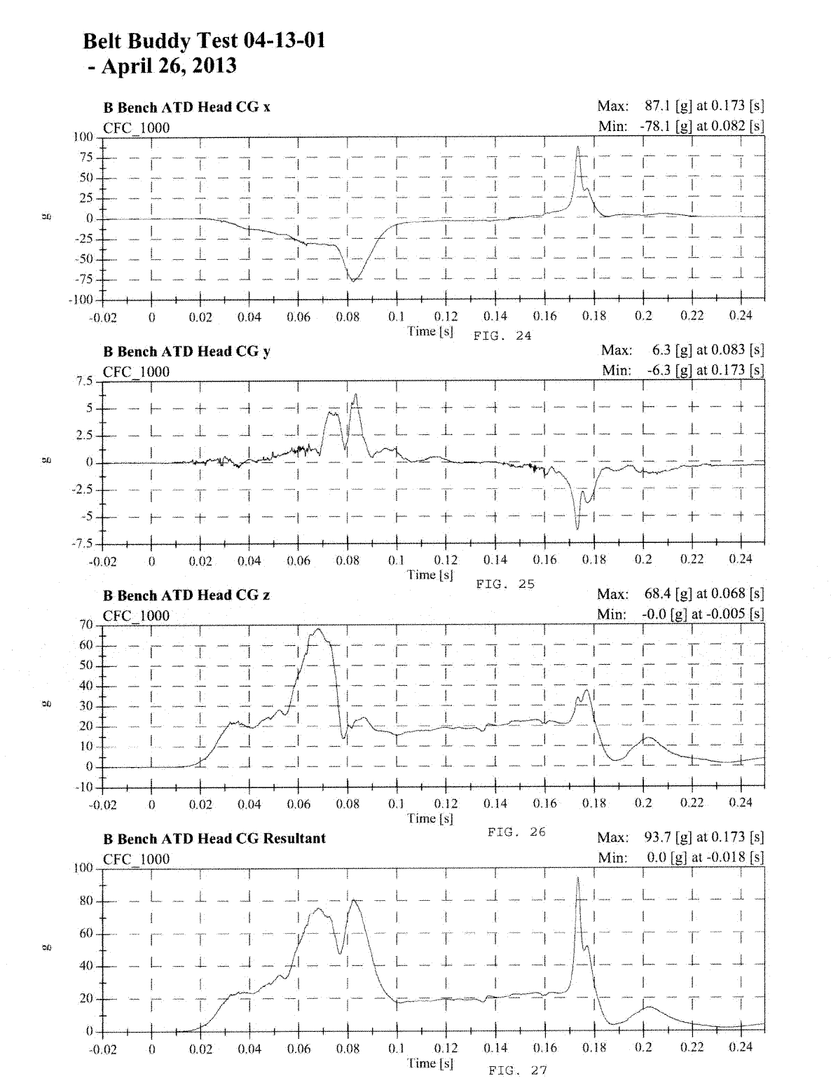

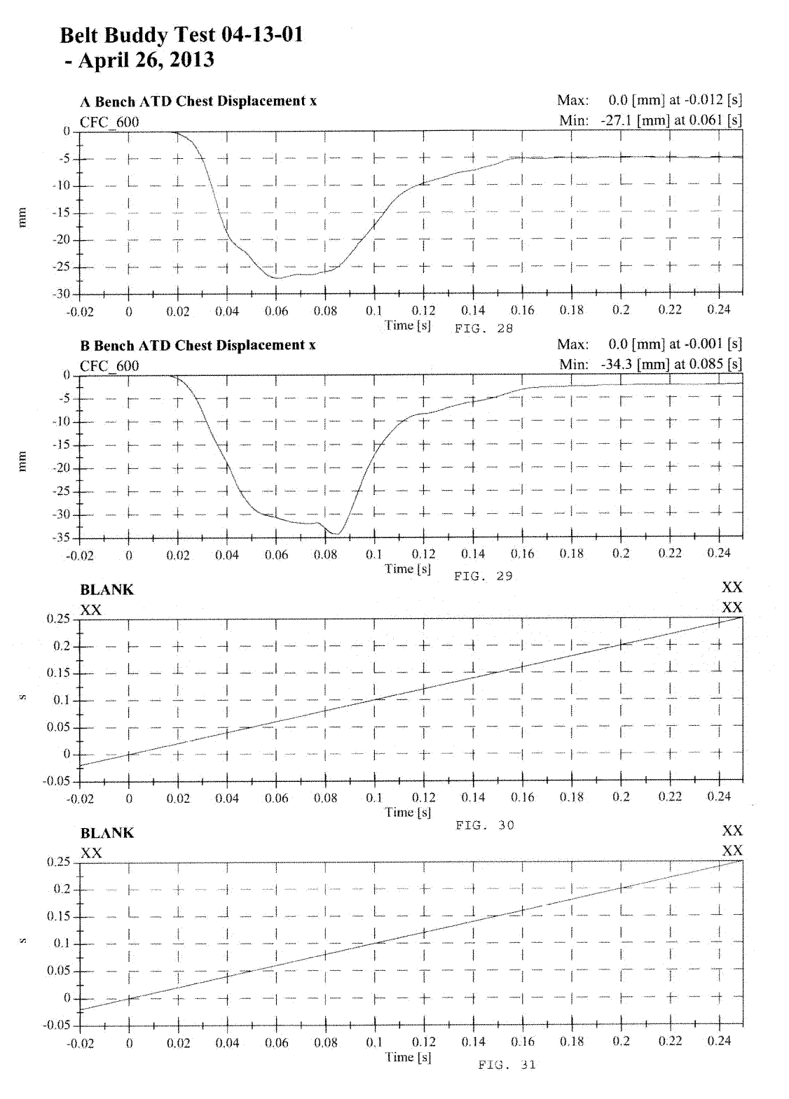

As shown in FIGS. 7 through 31, various studies have been conducted to determine the effectiveness of the seatbelt pillow product in various crash conditions with respect to head injury component, head and chest clip measurements, head and knee angle, and the like. In general, the results show In early test reports, it appears that the device of the present invention (also referred to as the Beltevator) shows that the HIC (Head Injury Component) index provides 90.8 g's less than with the seatbelt alone. As shown in the Figures, HIC-36 ms is head injury criteria. It is a unit less rating for head injury severity that NHTSA uses for their compliance evaluations. The 36 portion refers to the maximum time the differential equation can use for its calculations, the actual time frame is noted in summary.

Additionally, in early test reports it appears that the Beltevator shows that the Head Clips acceleration provides 5.3 g's less than with the seatbelt alone. As shown in the Figures, Head Clip-3 ms is a direct reading of the head acceleration and is reported in “g's”. This value is taken from the resultant plot of the three head channels and notes the maximum acceleration over a 3 ms interval to help remove any strange spikes or anomalies in data.

It should be understood, of course, that the foregoing relates to exemplary embodiments of the invention and that modifications may be made without departing from the spirit and scope of the invention as set forth in the following claims.

What is claimed is:

1. A seatbelt pillow comprising:
a resilient, pliable material, having a covering; and
a strap adapted to connect the seatbelt pillow to a seatbelt.
